(19) United States
(12) Patent Application Publication
(10) Pub. No.: US 2008/0120913 A1
(43) Pub. Date: May 29, 2008

(54) Sliding Door Comprising a Hermetic Closure Device Which is Intended to Withstand Internal Pressure

(75) Inventor: Narcis Lagares Corominas, Girona (ES)

Correspondence Address: RATNERPRESTIA, P O BOX 980, VALLEY FORGE, PA, 19482-0980, US

(73) Assignee: METALQUIMIA, SA, Girona (ES)

(21) Appl. No.: 11/547,485

(22) PCT Filed: Mar. 31, 2004
(86) PCT No.: PCT/ES04/00145

§ 371 Date: Sep. 18, 2007

(51) Int. Cl. E06B 5/00; E05D 15/06

(52) U.S. Cl. 49/449

(57) ABSTRACT

The invention relates to a sliding door comprising a hermetic closure device which is intended to withstand internal pressure. According to the invention, a panel is supported in a sliding manner in a guide system which is fixed in relation to an opening in a vertical wall of a closed structure. The guide system enables the panel to move: (i) longitudinally, parallel to the vertical wall, between an open position and a pre-closed position; and (ii) transversely between the pre-closed position and a hermetically-closed position. The invention comprises closure means which perform the aforementioned transverse movement by compressing a sealing strip between the panel and the wall, such that the panel is held in the hermetically-closed position by means of first, second and third closure elements which act respectively on front, rear and lower edges of the panel.

This application is a U.S. National Phase application of PCT Application No. PCT/ES2004/000145, filed Mar. 31, 2004.

### FIELD OF THE ART

This invention generally relates to a sliding door with a hermetic closure device which is intended to withstand internal pressure, and particularly to a sliding door including a sliding closure panel and a hermetic closure device comprising closure elements on at least two side edges and a lower edge of said closure panel to resist internal pressure.

### PRIOR ART

Sliding doors generally comprise at least one closure panel supported in a sliding manner in a guide system which is fixed in relation to an opening in a vertical wall. In doors with a low level of demand regarding the hermetic closure, the guide is parallel to said vertical wall and provides a slight separation between the latter and the closure panel to prevent mutual friction during the longitudinal movements for opening and closing the panel. However, this slight separation remains when the panel is opposite to the opening of the door in a closed position and it is difficult to hermetically close.

For those doors requiring a greater level of tightness, such as cold chamber doors, sliding doors have been designed with a hermetic closure device comprising a guide system adapted for guiding a longitudinal movement of the closure panel parallel to said vertical wall between an open position, in which the panel allows the passage through the opening of the door, and a pre-closed position in which the panel is opposite to said opening, and then a transverse movement between said pre-closed position and a hermetically-closed position, in which the panel is applied against the vertical wall covering the opening and preferably compressing a sealing strip or gasket around the perimeter of the opening.

Spanish patent ES-A-265801 discloses a closure panel suspension device for a sealed sliding door of the type described above in which the force for compressing said sealing strip or gasket is provided by the weight of the closure panel in cooperation with gravity during a transition between the pre-closed and hermetically-closed positions.

U.S. Pat. No. 5,280,686 discloses a sealed sliding door or window arrangement in which the transverse movement for tightening the sealing strip occurs at the end of the longitudinal movement due to the effect of the force used to carry out said longitudinal movement in cooperation with final guide portions in the transverse direction between the pre-closed and hermetically-closed positions. A locking element can be actuated to immobilize the panel in the hermetic closure position. U.S. Pat. No. 6,479,072 discloses a sliding closure panel of similar features.

Spanish patent ES-A-382942 discloses a mechanically actuated sliding door for the hermetic closure of cold chambers provided with an arrangement of guides allowing the mentioned longitudinal and transverse movements of the panel and a hermetic closure device comprising a rack and pinion mechanism for moving bars parallel to the panel for the purpose of making wedge-shaped ends of said bars project on opposite sides of the panel and coupling said ends in fixed configurations arranged on the corresponding sides of the opening. The action of said wedge-shaped ends against the fixed configurations pushes the panel in the transverse direction between the pre-closed and hermetically-closed positions pressing against the seal around the opening.

U.S. Pat. No. 4,688,352 discloses an automatic sliding door for a cold chamber including longitudinal guide and actuation means parallel to the vertical wall where the opening is located and transverse guide and actuation means perpendicular to said vertical wall. The mentioned transverse guide means are incorporated in the elements for suspending the panel from the longitudinal guide means, therefore they move together with the panel, whereas the transverse movement means comprise four linear actuators arranged in fixed positions suitable for being opposite to the four corners of the panel. The actuation of said linear actuators pushes the panel in the transverse direction between the pre-closed and hermetically-closed positions pressing against the seal around the opening.

The background documents cited above refer to a level of tightness suitable for thermal insulation, i.e. for securing air under atmospheric pressure.

International patent application WO 03/096815, belonging to the same applicant, discloses a food cooking installation comprising a plurality of cooking tanks for housing the foods to be cooked and means for loading and unloading said foods through a side opening existing in each of the cooking tanks. The opening of each tank is provided with a sliding closure panel provided with a longitudinal movement between open and pre-closed positions similar to those described above, and a transverse movement between the pre-closed position and a closed position pressing against a sealing strip or gasket around the opening. The installation includes means for filling each tank with at least one cooking liquid and for subsequently emptying it. Given that the tanks have a considerable height, for example to allow the passage of a person through their opening, the liquid contained therein exerts significant hydrostatic pressure against an inner face of the closure panel. For this reason, each tank is provided with closure means for at least partly carrying out said transverse movement and pressing against and securing the panel against the vertical wall of the tank in a bearing hermetically-closed position, said closure means being able to withstand the mentioned pressure created inside the tank.

However, the mentioned international patent application WO 03/096815 of the same applicant does not develop said hermetic closure means for a sliding door able to withstand internal pressure.

### DESCRIPTION OF THE INVENTION

This invention contributes to the mentioned development by providing a sliding door with a hermetic closure device which is intended to withstand internal pressure. The sliding door is of the type comprising at least one panel supported in a sliding manner in a guide system fixed in relation to an opening in a vertical wall of a closed structure having an inside and an outside. Said guide system is adapted for guiding the longitudinal movement of said panel parallel to said vertical wall between an open position in which the panel allows the passage through said opening, and a pre-closed position in which the panel is opposite to the opening, and a transverse movement between said pre-closed position and a bearing hermetically-closed position, in which the panel is applied against the vertical wall covering the opening and compressing a sealing strip around the perimeter of the opening. Closure means are incorporated for at least partly carrying out said transverse movement and for pressing against and securing the panel against the vertical wall in said bearing hermetically-closed position withstanding pressure created inside said closed structure. To that end, said closure means comprise at least one first closure element arranged to act on a front edge of the panel, at least one second closure element arranged to act on a rear edge of the panel and at least one third closure element arranged to act on a lower edge of the panel.

The terms “front edge” and “rear edge” of the panel are used throughout this specification to refer to the front and rear vertical edges of the panel in relation to the longitudinal movement thereof in a closure direction, respectively.

The closure means preferably comprise a plurality of first closure elements for acting on different areas of said front edge of the panel distributed along same, a plurality of second closure elements for acting on different areas of said rear edge of the panel distributed along same, and a plurality of third closure elements for acting on different areas of said lower edge of the panel distributed along same. With a suitable number of closure elements a substantially uniform pressure of the two side edges, the front and rear edges, and of the lower edge of the closure panel against the sealing strip is assured in the corresponding portions of the perimeter around the opening. The upper edge is also dragged by the side, front and rear edges of the panel against the sealing strip in the upper portion of the perimeter of the opening.

Since the hydrostatic pressure determines an increasing pressure gradient downwards, the greatest pressures are applied in the areas of the panel adjacent to the lower edge and to the lower portions of the side edges, whereas the pressures are minimal next to the upper edge of the panel. For this reason an embodiment of the sliding door of the invention described below does not envisage closure elements acting against the upper edge of the panel. However, in those cases in which the internal pressure is uniform on the entire panel, for example when it is exerted by a gas or vapor under pressure, the sliding door of the invention can incorporate closure elements acting on the upper edge of the panel in a manner similar to how the closure elements associated to the lower edge do.

The first, second and third closure elements are connected to respective first, second and third actuation mechanisms each including at least one cam integrally joined to a shaft actuated in rotation by an actuator, such as a fluid dynamic cylinder. However each of said first, second and third mechanisms has specific features aimed at adapting their closure elements to the particular positions they occupy in relation to the panel and taking into consideration the movements of the panel.

### BRIEF DESCRIPTION OF THE DRAWINGS

The foregoing and other features and advantages will be better understood from the following detailed description of an embodiment in reference to the attached drawings in which:

FIG. 1 shows a side elevational view of a cooking tank equipped with a sliding door with a hermetic closure device which is intended to resist internal pressure according to an embodiment of this invention;

FIG. 2 shows a front elevational view of the tank of FIG. 1 in which the closure panel has not been represented for the purpose of greater clarity of the drawing;

FIG. 3 shows a partial upper plan view of the tank of FIG. 1 in which the closure panel has been represented by means of continuous lines in the hermetically-closed position and dotted lines in the open position;

FIG. 4 shows a cross-sectional view of a first closure element provided so as to act on a front edge of the panel;

FIG. 5 shows a partial cross-sectional view of a second closure element provided so as to act on a rear edge of the panel;

FIG. 6A-6D show partially sectioned partial schematic plan views showing a sequence of movements of said first and second closure elements acting respectively on the front and rear edges of the panel in a transverse direction between partially opened, pre-closed and hermetically-closed positions;

FIG. 7 shows a partially sectioned partial side elevational view showing a third closure element acting on the lower edge of the panel in the hermetically-closed position; and

FIG. 8 shows a partial side elevational view similar to that of FIG. 8 showing a support roller fixed to the lower part of the tank and on which the panel is supported.

### DETAILED DESCRIPTION OF SEVERAL EMBODIMENTS

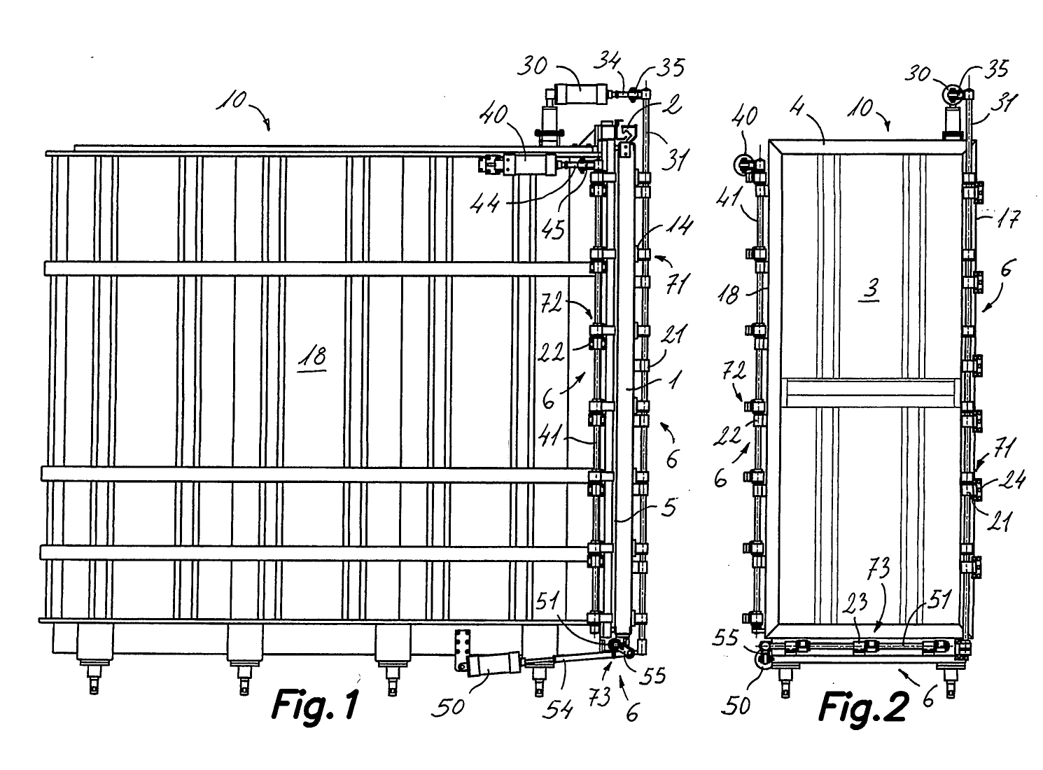

First in reference to FIGS. 1 and 2, reference number 10 indicates a closed structure having an inside and outside in the form of a cooking tank defined by vertical walls, a bottom wall and a top wall. In one of said vertical walls 4 there is an opening 3 through which the loading and unloading of the tank can be carried out. According to the embodiment shown and given the size of the opening 3, the vertical wall 4 is reduced to a surface in the way of a frame arranged around the opening 3. The remaining side walls are built using corrugated metal plates. A closure panel 1 is supported in a sliding manner in a guide system comprising at least one upper guide rail 2 fixed in relation to said opening 3. The cooking tank includes or is associated to means for filling and draining liquid from said closed structure 10.

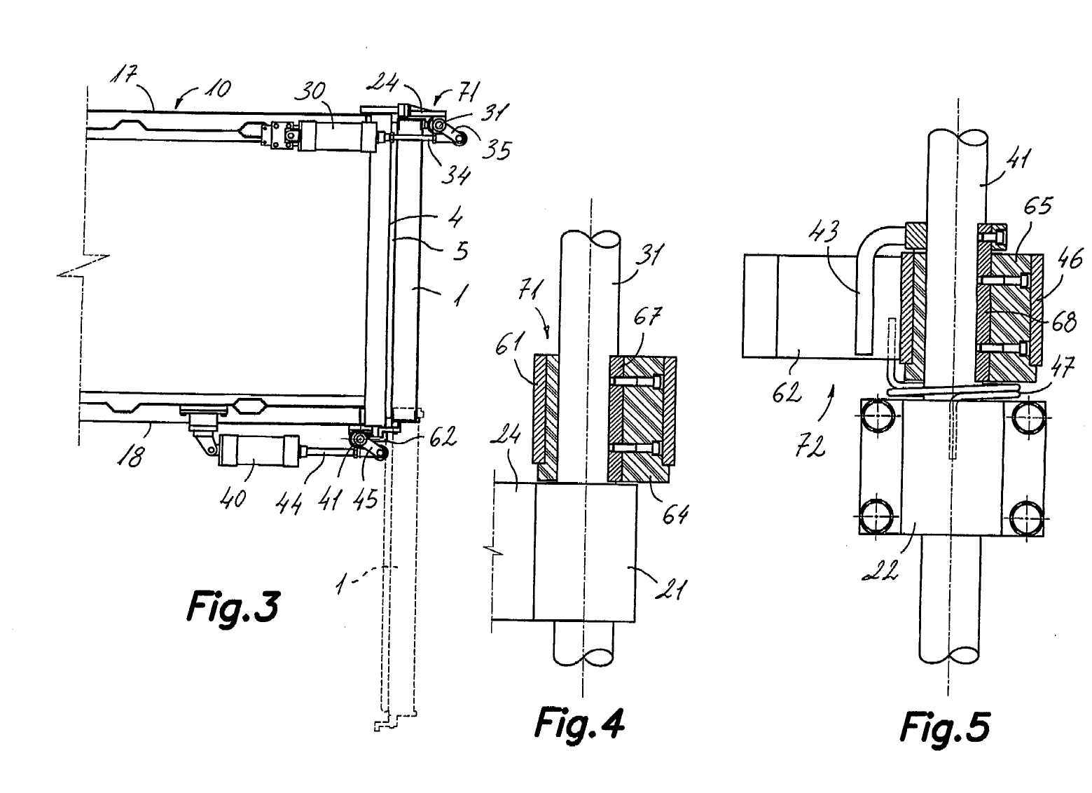

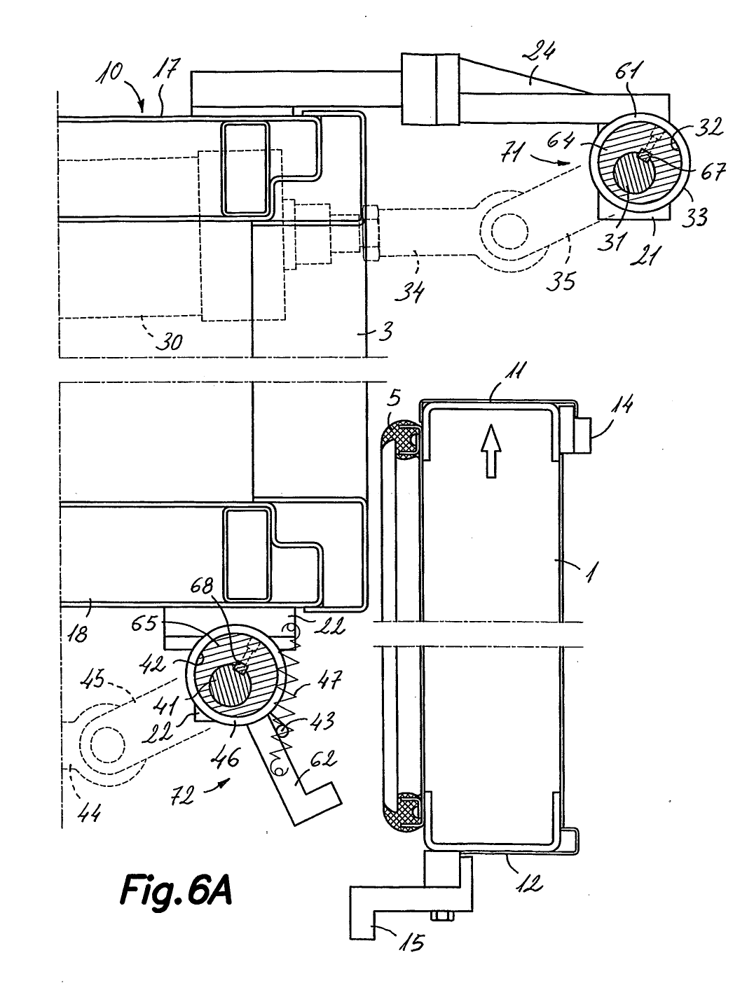

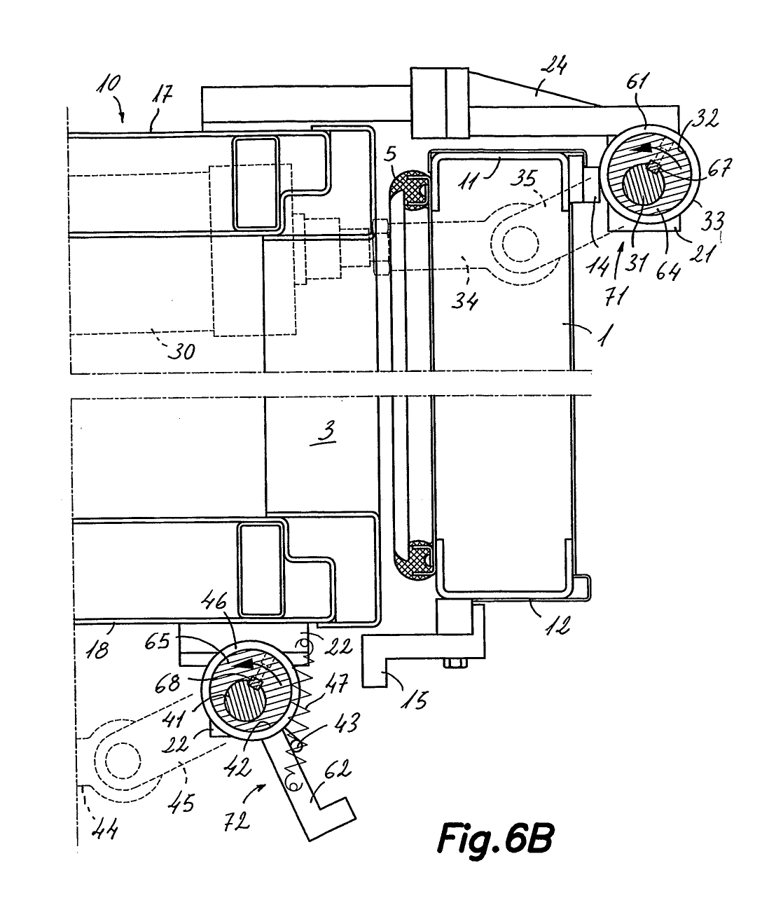

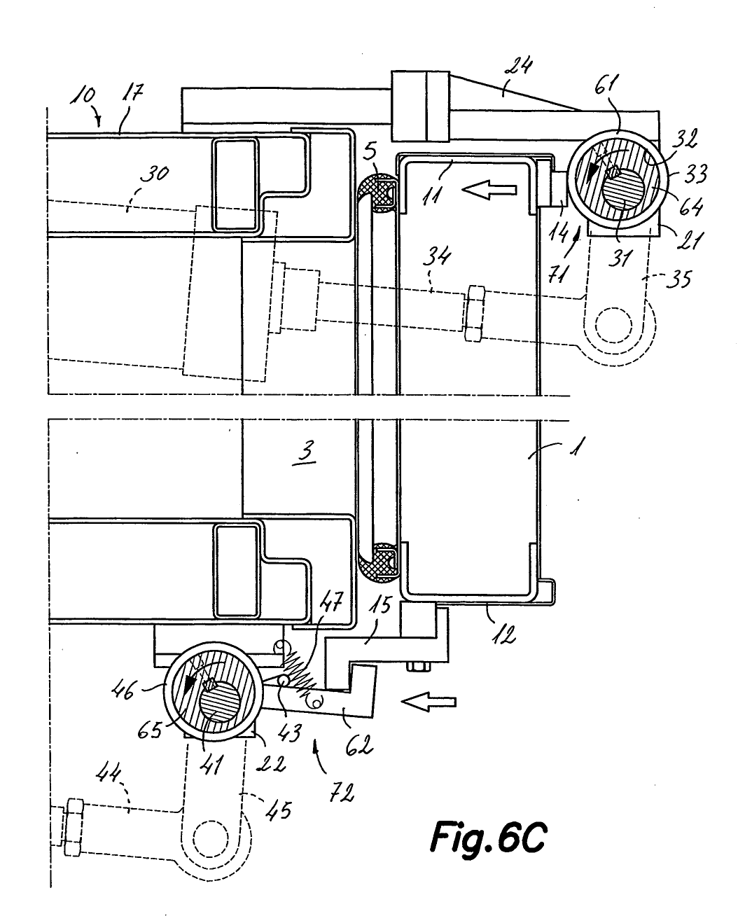

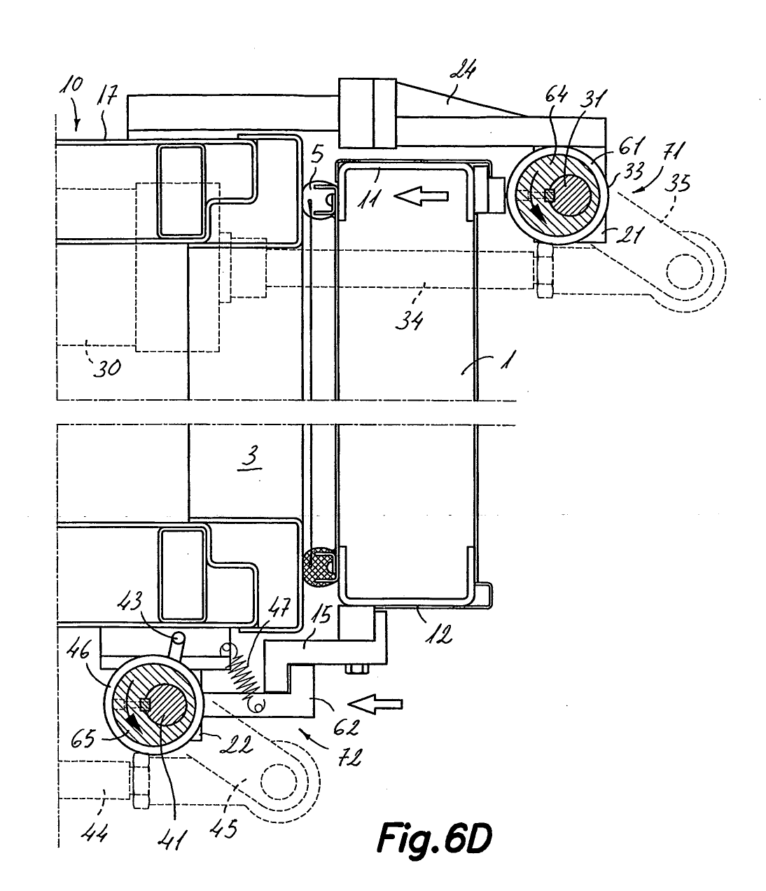

The mentioned guide system, including said upper guide rail 2, is of a known commercially available type and is adapted to guide a longitudinal movement of said panel 1, parallel to said vertical wall 4, between an open position (shown by means of dotted lines in FIG. 3) in which panel 1 allows the passage through said opening 3 and a pre-closed position (shown in FIG. 6B), in which panel 1 is opposite to the opening 3, and a transverse movement between said pre-closed position and a bearing hermetically-closed position (shown with continuous lines in FIG. 3) in which panel 1 is applied against the vertical wall 4, covering the opening 3 and compressing a sealing strip 5 arranged in the perimeter around the opening 3. In said applications said sealing strip 5 could encompass only part of the perimeter of the opening, for example the areas adjacent to the side edges and the lower edge of the opening 3.

Depending on the type of guide system used most of the transverse movement of the panel is carried out by a force provided by the weight of the panel 1 in cooperation with gravity at the end of the longitudinal closure movement. However, this force is not enough to press against the sealing strip 5 or to secure the panel in the hermetically-closed position withstanding internal pressure created by a cooking or cooling liquid filling the inside of the tank 10. To that end the sliding door of this invention has closing means 6 which allow carrying out at least a last part of said transverse closure movement, pressing against the sealing strip 5 between the panel 1 and the vertical wall 4, and securing the panel 1 in this bearing hermetically-closed position, withstanding the pressure created inside said closed structure 10.

According to the embodiment shown, the mentioned closure means 6 comprise a plurality of first closure elements 71 distributed along a front edge 11 of the panel 1 to act on different areas thereof, a plurality of second closure elements 72 distributed along a rear edge 12 of the panel 1 to act on different areas thereof, and a plurality of third closure elements 73 distributed along a lower edge 13 of the panel 1 to act on different areas thereof. However, in other applications not shown the closure means 6 can comprise a single first closure element for the front edge 11, a second closure element for the rear edge 12 and a single third closure element for the lower edge 13 of the panel 1. Also if needed, for example should the internal pressure be created by a gas or vapor, the closure means 6 could include one or more fourth closure elements to act on an upper edge of the panel 1 with an operation that is similar to that described below for third closure elements 73 associated to the lower edge 13 of the panel 1.

The mentioned first closure elements 71, one of which is shown in cross-section in FIG. 4, are connected to a first actuation mechanism including a first shaft 31 actuated in rotation by a first actuator 30 and a plurality of first cams 64 integrally joined to said first shaft 31, for example by means of respective first keys 67. Each of the first cams 64 is associated to a corresponding first closure element 71 which is made up of a cylindrical ring 61 having an inner surface 32 arranged to slide freely and rotatably on an outer surface of the corresponding first cam 64 and an outer surface 33 arranged to make rolling and pressure contact against a corresponding front surface 14 existing on said front edge 11 of the panel 1. This rolling and pressure contact begins when the panel 1 is in the pre-closed position and during at least part of the path between the pre-closed position and the hermetically-closed position as said first cam 64 is rotated. By virtue of the rotation of said first cams 64, the corresponding first closure elements 71 move and drag the front edge 11 of the panel 1 to the bearing hermetically-closed position.

In the embodiment shown, the first actuator 30 is a fluid dynamic cylinder (FIGS. 1 and 2) having a rod 34 connected to a lever arm 35 fixed to the first shaft 31. The mentioned fluid dynamic cylinder 30 is controlled by means of valve means to make the first shaft 31 rotate in a first direction a sufficient angle so that the rotation of the first cams 64 cause a movement of the first closure elements 71 suitable for carrying out at least in part the mentioned transverse movement of the panel 1 to the bearing hermetically-closed position, and in a second opposite direction to allow the reverse movement of the panel 1. The force transmitted by the mentioned first actuator 30 is enough to press against and deform said sealing strip 5, which is preferably of an elastic material and is joined to an inner face of the panel 1 defining a perimeter adapted to be coupled in an area of said vertical wall 4 of the closed structure 10 around the opening 3.

The first shaft 31 is vertically supported in a rotational manner in a position fixed in relation to the vertical wall 4 by means of a plurality of first supports 21 fixed to a side wall 17 of the closed structure 10 by means of respective arms 24 which, when the panel 1 is in the pre-closed or closed position, are opposite to the front edge 11 of the panel. Therefore the mentioned arms 24 and supports 21 support the first shaft 31 in a position such that the first closure elements 71 associated thereto are opposite to an outer face of an area adjacent to the front edge 11 of the panel 1 when the panel 1 is in the pre-closed or closed position. Fixed at suitable heights on said outer face of an area adjacent to the front edge 11 of the panel 1 are blocks of resistant material providing the corresponding front surfaces 14 on which the outer surfaces 33 of the first closure elements 71 make contact.

The first cams 64 are integrally joined to said first shaft 31 in identical angular positions and at different heights corresponding to the positions of the mentioned blocks, such that the first closure elements 71 act at the same time that the first shaft 31 is rotated.

The mentioned second closure elements 72, however, are connected to a second actuation mechanism including a plurality of second cams 65 integrally joined to a second shaft 41 by means of, for example, respective second keys 68, as shown in FIG. 5. The mentioned second shaft 41 is vertically supported in a rotational manner in a position fixed in relation to the vertical wall 4 by means of a plurality of second supports 22 fixed to a side wall 18 of the closed structure 10. Therefore the second shaft 41 is at all times outside of the movement path of the panel 1, as shown in FIGS. 2 and 6A-6D.

The mentioned second actuator 40 is, for example, a fluid dynamic cylinder having a body connected to the closed structure 10 and a rod 44 connected to a lever arm 45 fixed to the second shaft 41. This fluid dynamic cylinder 40 is controlled to rotate the second shaft 41 in both directions a predetermined angle that is enough to make the second closure elements 72 act.

As shown in FIGS. 6A-6D, each of said second closure elements 72 is made up of a gripping member 62, forming a hook-like angle, fixed externally to a cylindrical ring 46 having an inner surface 42 arranged to slide freely and rotatably on an outer surface of a respective second cam 65. Given that there is no mechanical connection as regards rotation between the second cam 65 and the cylindrical ring 46, provided for each second closure element 72 there is a pulling arm 43 fixed to said second shaft 41, for example, by means of the same corresponding second key 48, in a suitable position so that said pulling arm 43 can interfere with said gripping member 62, and an elastic means 47 is arranged to push the gripping member 62 against said pulling arm 43. All the second cams 65 and their corresponding pulling arms 43 are integrally joined in identical angular positions and at different heights along said second shaft 41 for the purpose of acting simultaneously as a result of the rotation of the second shaft 41.

The mentioned elastic member 47 can adopt various shapes. In some cases, as in the embodiment shown in FIG. 5, the mentioned elastic member 47 is in the shape of a helical torsion spring connected between the second gripping member 62 and a second support 22 of the second shaft 41. In FIGS. 6A-6D, the elastic member 47 is in the shape of a helical traction spring connected between the second gripping member 62 and said second support 22 of the second shaft 41.

The angular position in which the pulling arm 43 is fixed to the second shaft 41 is such that, in combination with said elastic means 47, it locks a first portion of the rotation of the second cam 65 in a first direction with the rotation of the gripping member 62 between a released position, shown in FIGS. 6A and 6B, in which the gripping member 62 does not interfere with the path of the panel 1 between its open and pre-closed positions, and a contact position shown in FIG. 6C in which the gripping member 62 is coupled to a projection 15 fixed on the rear edge 12 of the panel 1 when the panel 1 is in the pre-closed position. Throughout a second portion of the rotation of the second shaft 41 in said first direction, the second gripping member 62 is detained by the interference with said projection 15 while the pulling arm 43 continues rotating, together with the second cam 65, independently of the gripping member 62. During this second portion of the second shaft 41 in the first direction, the outer surface of the second cam 65 slides on said inner surface 42 of the cylindrical ring 46 and carries out a movement of the gripping member 62, which is coupled to said projection 15, therefore the gripping member 62 drags the rear edge 12 of the panel 1 towards the bearing hermetically-closed position pressing against the sealing strip 5, as shown in FIG. 6D.

When the second shaft 41 rotates in a second direction, the pulling arm 43 forces the rotation of the gripping member 62 in a second direction, opposite to the first one, against the force of the elastic means 47 until driving the gripping members 62 to the released position and allowing the reverse movement of the panel 1.

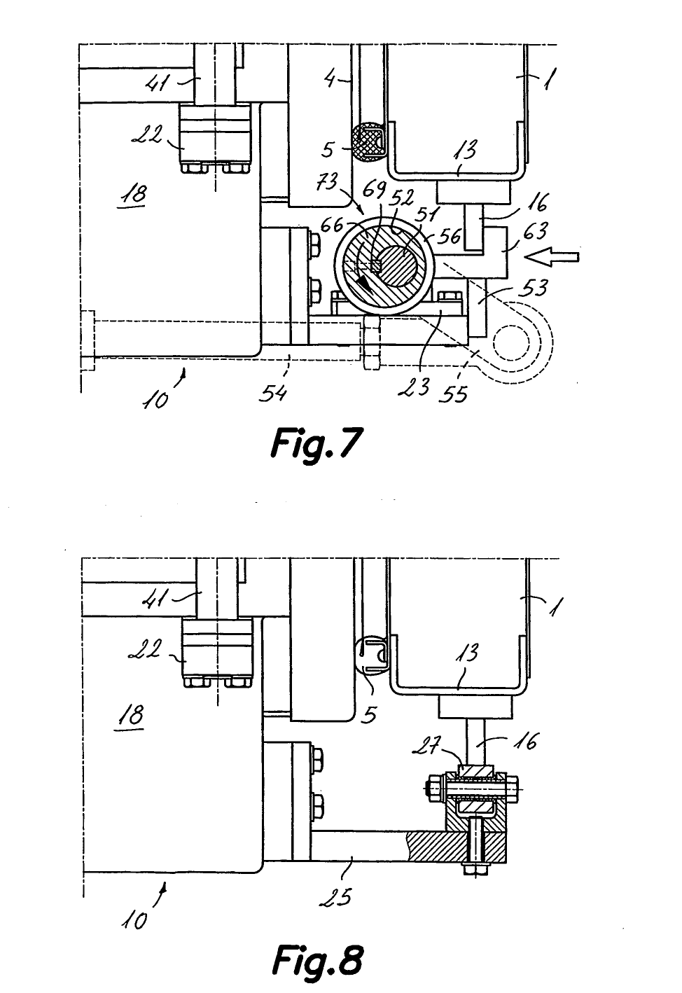

Said third closure elements 73, however, are connected to a third actuation mechanism including one or more third cams 66 integrally joined to a third shaft 51, for example, by means of corresponding third keys 69. This third shaft 51 is horizontally supported in a rotational manner in a position that is fixed in relation to the vertical wall 5 by means of a plurality of third supports 23 fixed to a lower part of the closed structure 10, as shown in FIGS. 1 and 7. All the third cams 66 are integrally joined to said third shaft 51 in identical angular positions and in different positions along same. The third shaft 51 is actuated by a third actuator 50 which, in the embodiment shown in the figures, is a fluid dynamic cylinder the rod 54 of which is connected to a lever arm 55 fixed to the third shaft 51. The mentioned fluid dynamic cylinder 50 is controlled to make the third shaft 51 rotate a predetermined angle in both directions.

As is best shown in FIG. 7, each of the mentioned third closure elements 73 is made up of a hook-like gripping member 63 fixed externally to a cylindrical ring 56 having an inner surface 52 arranged to slide freely and rotatably on an outer surface of a respective third cam 66. Given that there is no mechanical connection as regards the rotation between each third cam 66 and their corresponding cylindrical ring 56, arranged under the gripping members 63 there is a stationary lower support 53 on which said gripping member 63 rests with the ability to slide to prevent the gripping members 63 from rotating due to the effect of gravity.

Therefore, during a first portion of the rotation of the third shaft 51 in a first direction in a predetermined angle, the third cam 66 rotates an equal angle that is sufficient for the mentioned outer surface of the third cam 66 to slide on said inner surface 52 of the cylindrical ring 56, carrying out a movement of the gripping member 63, sliding in a supported manner on said lower support 53 between a released position in which the gripping member 63 does not interfere with the path of the panel 1 between its open and pre-closed positions, and an intermediate contact position in which the gripping member 63 is coupled to a projection 16 fixed on the lower edge 13 of the panel 1 when said panel is in the pre-closed position. During a second portion of rotation of the third shaft 51 in said first direction, the third cam 66 continues to rotate, carrying out the movement of gripping member 63 between said intermediate contact position and a final closed position in which said projection 16 has been dragged together with the rear edge 12 of the panel 1 to the bearing hermetically-closed position, as shown in FIG. 7.

Note that so as to not interfere in the movement of the panel 1 it is enough for the gripping member 63 to be slightly separated from said projection 16 in the released position, a rotation of the gripping members 63 in relation to the shaft 51 not being necessary. For this reason the third closure elements 73 do not include pulling arms such as those shown in relation to the second closure elements 72. By means of a rotation of the third shaft 51 in a second direction opposite to the first one, the third cam 66 rotates so as to drive the gripping members 63 again to the released position and allow the reverse movement of the panel 1.

In relation to FIGS. 6A-6D again, they show a sequence of coordinated movements of the first and second closure elements 71, 72 acting respectively on the front and rear edges 11, 12 of the panel 1 in the transverse direction between partially open, pre-closed and hermetically-closed positions. It must be pointed out that even though it cannot be seen in FIGS. 6A-6D, in each of the steps of said sequence the third closure elements 73 also act on the lower edge 13 of the panel 1 in coordination with the first and second closure elements 71, 72.

Thus, FIG. 6A shows the first and second closure elements 71, 72 in the released position, whereas panel 1 is moving in the direction of the arrow between its open and pre-closed positions. In this released position, neither the first closure element 71 nor the gripping member 62 of the second closure element 72 interferes with panel 1 in its path.

FIG. 6B shows the first and second closure elements 71, 72 in the released position, whereas panel 1 is already in the pre-closed position, in which panel 1 is opposite to the opening 3 but without hermetically closing the opening 3. Depending on the type of guide system, or more specifically on the type of upper guide rail 2 used, panel 1 in the pre-closed position is slightly separated from the front vertical wall 4 of the cooking tank or will be in contact with the vertical wall 4 but the sealing strip 5 not being pressed against. In any case the upper guide rail 2 allows a transverse movement of panel 1 from the pre-closed position shown in FIG. 6B towards the vertical wall 4. It can be seen that the first closure element 71 is opposite to the front surface 14 of the block fixed to the outer face of an area adjacent to the front edge 11 of the panel 1.

FIG. 6C shows the situation when the first and second shafts 31, 41 have carried out a first portion of their respective rotations in the closure direction due to the effect of the actuation of the respective fluid dynamic cylinders 30, 40. The first cam 64 has rotated an angle corresponding to the angle that the first shaft 31 has rotated and has therefore moved the cylindrical ring 61, the outer surface 33 of which has started a rolling and pressure contact against the front surface 14 of the corresponding block. At the same time the second cam 65 and the pulling arm 43 have rotated an angle corresponding to the angle that the second shaft 41 has rotated. In this first portion of the rotation of the second shaft 41, the cylindrical ring 46 and the gripping member 62 have also rotated together with the pulling arm 43 due to the effect of the stress exerted by the elastic means 47 until the gripping member 62 is coupled to the projection 15 fixed on the rear edge 12 of the panel 1. At this time the rotation of the gripping member 62 is stopped due to contact with the projection 15 although the second shaft 41 continues to rotate, as will be explained below in relation to FIG. 6D.

FIG. 6D shows a final position in which the first and second shafts 31, 41 have concluded their respective rotations in the closure direction due to the effect of the actuation of the respective fluid dynamic cylinders 30, 40 and the panel 1 is in its bearing hermetically-closed position. Between the situations shown in FIGS. 6C and 6D, the first cam 64 has continued to rotate in the closure direction and therefore to move the cylindrical ring 61 such that its outer surface 33 has progressively been making the mentioned rolling and pressure contact against the front surface 14 of the corresponding block, dragging with it the front edge 11 of the panel 1 to the bearing hermetically-closed position in which the sealing strip 5 is compressed between the panel 1 and the vertical wall 4. The second cam 65 and the pulling arm 43 have continued to rotate, but now the pulling arm 43 does not drag the gripping member 62, but rather the latter remains in coupling contact with the projection 15 whereas due to the effect of the rotation of the second cam 65, a progressive movement of the cylindrical ring 46 and of the gripping member 62 in the direction indicated by the arrow in FIG. 6D occurs, dragging with it the rear edge 12 of the panel 1 to the bearing hermetically-closed position in which the sealing strip 5 is compressed between the panel 1 and the vertical wall 4.

At the same time as the steps carried out by the first and second closure elements 71, 72 during the closure sequence described in relation to FIGS. 6A to 6D, the third closure elements 73 have carried out equivalent steps in which the corresponding gripping member 73 does not substantially change its angular position given that it is supported at all times by the stationary lower support 53. Therefore, due to the effect of the rotation of the third shaft 51 and of the third cam 66, the third cylindrical ring 56 and the gripping member 76 fixed thereto only substantially experience a movement in the direction shown by an arrow in FIG. 7, dragging with it the lower edge 13 of the panel 1 to the bearing hermetically-closed position in which the sealing strip 5 is compressed between the panel 1 and the vertical wall 4.

Due to the movement of the front edge 11, rear edge 12 and lower edge 13 of the panel 1, the upper edge also moves, compressing the corresponding portion of the sealing strip 5 between the panel 1 and the vertical wall 4. If it is considered necessary to incorporate closure elements (not shown) to act on said upper edge of the panel, a fourth shaft would be assembled in a horizontal position actuated by a fourth actuator and fourth closure elements associated to cam mechanisms fixed to the fourth shaft similar to those described in relation to FIG. 7 for the lower edge 13 of the panel 1, though in a reversed position. In this case, the corresponding gripping members of the fourth closure elements would be coupled to a projection fixed on the upper edge of the panel which at the same time could act as a support element to prevent the rotation of the gripping members due to the effect of gravity. A stop element located for example in the upper part would be appropriate to prevent accidental rotation of the gripping members in the opposite direction.

To actuate said longitudinal movement of the panel 1 in the direction parallel to said vertical wall 4 between the open position and the pre-closed position or vice-versa, the sliding door may include in a well known manner at least one actuator (not shown), such as a fluid dynamic cylinder or an electric motor. Depending on the type of guide system used, the mentioned actuator may also actuate at least one part of said transverse movement between the pre-closed position and the bearing hermetically-closed position or vice-versa.

In reference to FIG. 8, in the embodiment shown in addition to the mentioned upper guide rail 2 from which the panel 1 is suspended (FIG. 2), the guide system comprises a plurality of support rollers 27 on which the panel 1 is supported. The mentioned support rollers 27 are assembled in a freely rotational manner in supports 25 fixed along the lower part of the vertical wall 4, and the same projection 16 fixed on the lower edge 13 of the panel 1 to which the gripping members 63 of the third closure elements 73 are coupled (FIG. 7) may have a planar and continuous lower surface suitable for being supported on the support rollers 27. The presence of these support rollers 27 is necessary only in the area adjacent to the opening 3 of the cooking tank 10 in those cases in which the upper guide rail 2 of the guide system allows a downward movement of the panel 1 at the same time that it allows transverse movement between the pre-closed and closed positions.

The sliding door according to this invention described and illustrated up to this point is suitable for being incorporated in a food cooking installation, of the type described in the mentioned international patent application WO 03/096815. Such installation comprises a plurality of food cooking tanks arranged in an organized manner along at least one path. Each cooking tank is provided with a closed structure 10 having an inside and an outside, at least one opening 3 in a vertical wall 4 of said closed structure 10 through which foods to be cooked can be loaded and unloaded, and at least one sliding door for opening and closing said opening 3. The installation further has an automatic device for loading and unloading foods to be cooked from said tanks through their respective openings and along the mentioned path, and means for selectively filling and draining from each one of the tanks a cooking or cooling liquid or fluid.

The embodiments described and shown have a merely illustrative and non-limiting character, and a person skilled in the art may conceive modifications and variations without departing from the scope of the invention as it is defined in the attached claims. For example, it is possible to fix on each of the first, second and third shafts 31, 41, 51 a first, second and third cam 64, 65, 66 of great length, respectively, and several of the respective first, second and third closure elements 71, 72, 73 could be assembled on each of said cams.

1. A sliding door with a hermetic closure device which is intended to withstand internal pressure, of the type comprising at least one panel (1) supported in a sliding manner in a guide system fixed in relation to an opening (3) in a vertical wall (4) of a closed structure (10) having an inside and an outside, said panel (1) having a front edge (11) and a rear edge (12), said guide system being adapted for guiding the longitudinal movement of said panel (1) parallel to said vertical wall (4) between an open position in which the panel (1) allows the passage through said opening (3), and a pre-closed position in which the panel (1) is opposite to the opening (3), and a transverse movement between said pre-closed position and a bearing hermetically-closed position, in which the panel (1) is applied against the vertical wall (4) covering the opening (3) and compressing a sealing strip (5) in at least part of the perimeter of the opening (3), closure means (6) being incorporated for at least partly carrying out said transverse movement and for pressing against and securing the panel (1) against the vertical wall (4) in said bearing hermetically-closed position withstanding pressure created inside said closed structure (10), characterized in that said closure means (6) comprise at least one first closure element (71) arranged to act on said front edge (11) of the panel (1), at least one second closure element (72) arranged to act on said rear edge (12) of the panel (1) and at least one third closure element (73) arranged to act on a lower edge (13) of the panel (1).

2. A sliding door according to claim 1, characterized in that said closure means (6) comprise a plurality of first closure elements (71) for acting on different areas of said front edge (11) of the panel (1) distributed along same, a plurality of second closure elements (72) for acting on different areas of said rear edge (12) of the panel (1) distributed along same, and a plurality of third closure elements (73) for acting on different areas of said lower edge (13) of the panel (1) distributed along same.

3. A sliding door according to claim 2, characterized in that said first closure elements (71) are connected to a first actuation mechanism including at least one first cam (64) integrally joined to a first shaft (31) actuated in rotation by a first actuator (30), said second closure elements (72) are connected to a second actuation mechanism including at least one second cam (65) integrally joined to a second shaft (41) actuated in rotation by a second actuator (40) and said third closure elements (73) are connected to a third actuation mechanism including at least one third cam (66) integrally joined to a third shaft (51) actuated in rotation by a third actuator (50).

4. A sliding door according to claim 3, characterized in that each of said first closure elements (71) is made up of a cylindrical ring (61) having an inner surface (32) arranged to slide freely and rotatably on an outer surface of a respective first cam (64) and an outer surface (33) arranged to make rolling and pressure contact, when the panel (1) is in the pre-closed position and as said first cam (64) is rotated, against a corresponding front surface (14) existing on said front edge (11) of the panel (1), dragging the front edge (11) of the panel (1) to the bearing hermetically-closed position.

5. A sliding door according to claim 4, characterized in that said first shaft (31) is vertically supported in a rotational manner in a position fixed in relation to the vertical wall (4) and all the first cams (64) are integrally joined to said first shaft (31) in identical angular positions and at different heights, said fixed position of the first shaft (31) being such that the first closure elements (71) are opposite to their corresponding front surfaces (14) when the panel (1) is in the pre-closed position, the bearing hermetically-closed position or any intermediate position.

6. A sliding door according to claim 5, characterized in that it comprises a plurality of first supports (21) to support in a rotational manner the first shaft (31), said first supports (21) being fixed to the closed structure (10) by means of respective arms (24) located in positions such that the first shaft (31) and the first closure elements (71) associated thereto are opposite to an area adjacent to the front edge (11) of the panel (1) when the panel (1) is in the pre-closed position, the bearing hermetically-closed position or any intermediate position.

7. A sliding door according to claim 5, characterized in that said front surfaces (14) are incorporated in blocks fixed at suitable heights on an external face of the panel (1) in the area of the front edge (11).

8. A sliding door according to claim 5, characterized in that said first actuator (30) is a fluid dynamic cylinder the rod (34) of which is connected to a lever arm (35) fixed to the first shaft (31) and is controlled to make the first shaft (31) rotate in a first direction a sufficient angle so that the rotation of the first cams (64) cause the movement of the first closure elements (71) suitable for carrying out at least in part the transverse movement of the panel (1) to the bearing hermetically-closed position, and in a second opposite direction for allowing the reverse movement of the panel (1).

9. A sliding door according to claim 3, characterized in that each of said second closure elements (72) is made up of a gripping member (62) fixed externally to a cylindrical ring (46) with an inner surface (42) arranged to freely and rotatably slide on an outer surface of a respective second cam (65), a pulling arm (43) fixed to said second shaft (41) being arranged in a position susceptible to interfering with said gripping member (62) and an elastic means (47) pushing the gripping member (62) against said pulling arm (43).

10. A sliding door according to claim 9, characterized in that the angular position of the pulling arm (43) is such that in combination with said elastic means (47) it locks a first portion of the rotation of the second cam (65) with the rotation of the gripping member (62) between a released position in which the gripping member (62) does not interfere with the path of the panel (1) between its open and pre-closed positions, and a contact position in which the gripping member (62) is coupled to a projection (15) fixed on the rear edge (12) of the panel (1) when the panel (1) is in the pre-closed position, and allows a second portion of the rotation of the second cam (65) independent of the gripping member (62) during which rotation said outer surface of the second cam (65) slides on said inner surface (42) of the cylindrical ring (46), carrying out a movement of the gripping member (62) coupled to said projection (15), dragging with it the rear edge (12) of the panel (1) towards the bearing hermetically-closed position.

11. A sliding door according to claim 10, characterized in that said second shaft (41) is vertically supported in a rotational manner in a position that is fixed in relation to the vertical wall (4) and all the second cams (65) and their corresponding pulling arms (43) are integrally joined in identical angular positions and at different heights to said second shaft (41).

12. A sliding door according to claim 11, characterized in that it comprises a plurality of second supports (22) to support in a rotational manner the second shaft (41), said second supports (22) being fixed to a side wall (18) of the closed structure (10).

13. A sliding door according to claim 11, characterized in that said second actuator (40) is a fluid dynamic cylinder with a body connected to the closed structure (10) and a rod (44) connected to a lever arm (45) fixed to the second shaft (41), and said fluid dynamic cylinder (40) being controlled to make the second shaft (41) rotate in a first direction an angle that is sufficient to make the gripping members (62) rotate between the released and contact positions and so that the rotation of the second cams (65) then causes a movement of the gripping members (62) that is suitable to carry out at least in part the transverse movement of the panel (1) to the bearing hermetically-closed position, and in a second opposite direction to allow the reverse movement of the panel (1) and drive the gripping members (62) to the released position.

14. A sliding door according to claim 3, characterized in that each of said third closure elements (73) is made up of a gripping member (63) fixed externally to a cylindrical ring (56) with an inner surface (52) arranged to slide freely and rotatably on an outer surface of a respective third cam (66), a stationary lower support (53) being arranged on which said gripping member (63) is supported due to gravity with the ability to slide.

15. A sliding door according to claim 14, characterized in that during the rotation of the third cam (66), said outer surface of the third cam (66) slides on said inner surface (52) of the cylindrical ring (56), carrying out a movement of the gripping member (63) sliding in a supported manner on said lower support (53) between a released position in which the gripping member (63) does not interfere with the path of the panel (1) between its open and pre-closed positions, an intermediate contact position in which the gripping member (63) is coupled to a projection (16) fixed on the lower edge (13) of the panel (1) when said panel is in the pre-closed position, and a final closed position in which said projection (16) has been dragged together with the rear edge (12) of the panel (1) to the bearing hermetically-closed position.

16. A sliding door according to claim 15, characterized in that said third shaft (51) is horizontally supported in a rotational manner in a position that is fixed in relation to the vertical wall (5) and all the third cams (66) are integrally joined to said third shaft (51) in identical angular positions and in different positions along same.

17. A sliding door according to claim 16, characterized in that it comprises a plurality of third supports (23) to rotatably support the third shaft (51), said third supports (23) being fixed to the closed structure (10).

18. A sliding door according to claim 16, characterized in that said third actuator (50) is a fluid dynamic cylinder the rod (54) of which is connected to a lever arm (55) fixed to the third shaft (51) and is controlled to make the third shaft (51) rotate in a first direction an angle that is sufficient make the gripping members (63) rotate between the released and contact position and so that the rotation of the third cams (65) causes a movement of the gripping members (63) suitable for carrying out at least in part the transverse movement of the panel (1) to the bearing hermetically-closed position, and in a second opposite direction to allow the reverse movement of the panel (1) and drive the gripping members (63) to the released position.

19. A sliding door according to claim 3, characterized in that said sealing strip (5) is joined to an inner face of the panel (1) defining a perimeter adapted to be coupled in an area of said vertical wall (4) of the closed structure (10) around the opening (3).

20. A sliding door according to claim 3, characterized in that it comprises at least one actuator to actuate said longitudinal movement of the panel (1) parallel to said vertical wall (4) between the open position and the pre-closed position, and at least part of said transverse movement between the pre-closed position and the bearing hermetically-closed position.

21. A sliding door according to claim 3, characterized in that said guide system comprises at least one upper guide rail (2) from which the panel (1) is suspended and a plurality of support rollers (27) on which the panel (1) is supported.

22. A food cooking tank of the type comprising a closed structure (10) having an inside and an outside, at least one opening (3) in a vertical wall (4) through which foods to be cooked can be loaded and unloaded, a sliding door for opening and closing said opening (3) and means for filling and draining liquid from said closed structure (10), characterized in that said sliding door is a sliding door with a hermetic closure device which is intended to withstand internal pressure according to any of the previous claims.

23. A food cooking installation of the type comprising a plurality of food cooking tanks, each provided with a closed structure (10) having an inside and an outside, at least one opening (3) in a vertical wall (4) of said closed structure (10) through which foods to be cooked can be loaded and unloaded, a sliding door for opening and closing said opening (3), an automatic device for loading and unloading foods in/from said tanks and means for selectively filling and draining liquid from each of the tanks, characterized in that said sliding door of each tank is a sliding door with a hermetic closure device which is intended to withstand internal pressure according to any one of claims 1 to 20.
